(19) United States
(12) Patent Application Publication
(10) Pub. No.: US 2023/0326665 A1
(43) Pub. Date: Oct. 12, 2023

(54) COIL COMPONENT

(71) Applicant: SAMSUNG ELECTRO-MECHANICS CO., LTD., Suwon-si (KR)

(72) Inventors: Jae Hun KIM, Suwon-si (KR); In Young KANG, Suwon-si (KR)

(73) Assignee: SAMSUNG ELECTRO-MECHANICS CO., LTD., Suwon-si (KR)

(21) Appl. No.: 18/093,595

(22) Filed: Jan. 5, 2023

(30) Foreign Application Priority Data
Apr. 6, 2022 (KR) 10-2022-0042982

(51) Int. Cl. H01F 27/29; H01F 27/02; H01F 27/32

(52) U.S. Cl. CPC H01F 27/292; H01F 27/022; H01F 27/32

(57) ABSTRACT

A coil component includes a body having a first surface and a second surface opposing each other, and a first side surface and a second side surface connecting the first surface to the second surface and opposing each other, a wound coil disposed in the body, and including a wound portion wound around a winding axis perpendicular to the first side surface of the body and first and second lead-out portions spaced apart from each other on the first side surface of the body, and first and second external electrodes spaced apart from each other on the first surface of the body, extending only onto the first side surface of the body and connected to the first and second lead-out portions, respectively.

### CROSS-REFERENCE TO RELATED APPLICATION(S)

This application claims the benefit of priority to Korean Patent Application No. 10-2022-0042982 filed on Apr. 6, 2022 in the Korean Intellectual Property Office, the disclosure of which is incorporated herein by reference in its entirety.

### BACKGROUND

### 1. Technical Field

The present disclosure relates to a coil component.

### 2. Description of Related Art

A magnetic mold and a wound coil may be used to manufacture a coil component.

Coil components have been required to have a reduced size and a low-profile to be installed in a limited space.

There has been demand for a coil component having a reduced size, a low-profile and high capacitance properties, and preventing short circuit with an adjacent component therein to easily perform integration of a coil component.

### SUMMARY

An aspect of the present disclosure is to provide a coil component which may have a reduced size and a low-profile and may secure an effective volume such that high capacitance properties may be implemented.

An aspect of the present disclosure is to provide a coil component in which short circuits with adjacent components may be prevented when being mounted on a printed circuit board, such that integration may be easily performed.

According to an aspect of the present disclosure, a coil component includes a body having a first surface and a second surface opposing each other, and a first side surface and a second side surface connecting the first surface to the second surface and opposing each other, a wound coil disposed in the body, and including a wound portion wound around a winding axis perpendicular to the first side surface of the body and first and second lead-out portions spaced apart from each other on the first side surface of the body, and first and second external electrodes spaced apart from each other on the first surface of the body, extending only onto the first side surface of the body and connected to the first and second lead-out portions, respectively.

According to another aspect of the present disclosure, a coil component includes a body having a first surface and a second surface opposing each other, and a first side surface and a second side surface connecting the first surface to the second surface and opposing each other, a wound coil disposed in the body, and including a wound portion wound around a winding axis perpendicular to the first side surface of the body and first and second lead-out portions spaced apart from each other, and first and second external electrodes spaced apart from each other, each having an ‘L’ shape disposed on the first surface and the first side surface of the body, the first and second external electrodes being connected to the first and second lead-out portions, respectively.

According to still another aspect of the present disclosure, a coil component includes a body having a first surface and a second surface opposing each other, and a first side surface and a second side surface connecting the first surface to the second surface and opposing each other, a wound coil disposed in the body, and including a wound portion wound around a winding axis perpendicular to the first side surface of the body and first and second lead-out portions spaced apart from each other on the first side surface of the body, and first and second external electrodes spaced apart from each other, disposed on the first surface and the first side surface of the body, and connected to the first and second lead-out portions, respectively.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to an example embodiment of the present disclosure;

FIG. 2 is an exploded perspective diagram illustrating the coil component illustrated in FIG. 1;

FIG. 3 is a diagram illustrating the coil component illustrated in FIG. 1, viewed in direction A;

FIG. 4 is a diagram illustrating the coil component illustrated in FIG. 1, viewed in direction B;

FIG. 5 is a diagram illustrating the coil component illustrated in FIG. 1, viewed in direction C;

FIG. 6 is a cross-sectional diagram taken along I-I′ in FIG. 1;

FIG. 7 is a diagram illustrating the coil component in FIG. 1 according to a second example embodiment, viewed in direction D;

FIG. 8 is a diagram illustrating the coil component in FIG. 1 according to a third example embodiment, viewed in direction D;

FIG. 9 is a perspective diagram illustrating a coil component according to a fourth example embodiment;

FIG. 10 is a diagram illustrating a mold portion of a coil component according to a fourth example embodiment;

FIG. 11 is a diagram illustrating a distance between coil components having a U-shaped external electrode when being mounted on a printed circuit board; and

FIG. 12 is a diagram illustrating a distance between coil components having a L-shaped external electrode when being mounted on a printed circuit board as in the example embodiment.

### DETAILED DESCRIPTION

The terms used in the example embodiments are used to simply describe an example embodiment, and are not intended to limit the present disclosure. A singular term includes a plural form unless otherwise indicated. The terms, “include,” “comprise,” “is configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof. Also, the term “disposed on,” “positioned on,” and the like, may indicate that an element is positioned on or beneath an object, and does not necessarily mean that the element is positioned on the object with reference to a gravity direction.

The term “coupled to,” “combined to,” and the like, may not only indicate that elements are directly and physically in contact with each other, but also include the configuration in which the other element is interposed between the elements such that the elements are also in contact with the other component.

Sizes and thicknesses of elements illustrated in the lead-out portions are indicated as examples for ease of description, and example embodiments in the present disclosure an example embodiment thereof is not limited thereto.

In the drawings, an L direction is a first direction or a length direction, a W direction is a second direction or a width direction, a T direction is a third direction or a thickness direction.

In the descriptions described with reference to the accompanied lead-out portions, the same elements or elements corresponding to each other will be described using the same reference numerals, and overlapped descriptions will not be repeated.

In electronic devices, various types of electronic components may be used, and various types of coil components may be used between the electronic components to remove noise, or for other purposes.

In other words, in electronic devices, a power inductor, a high frequency inductor (HF inductor), a general bead, a high frequency bead (GHz bead), a common mode filter, and the like.

### First Embodiment

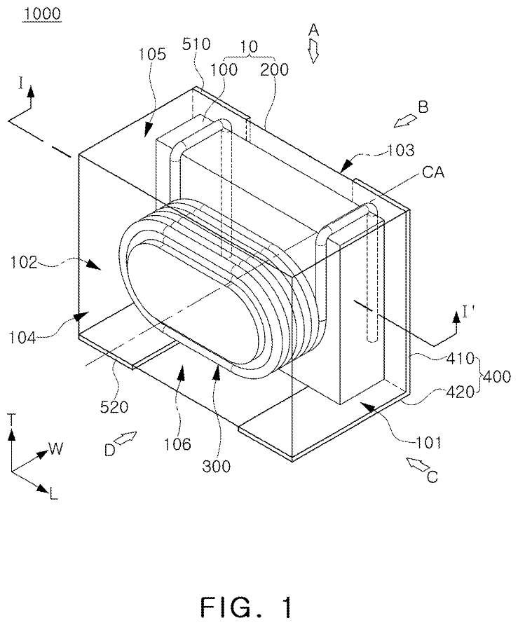

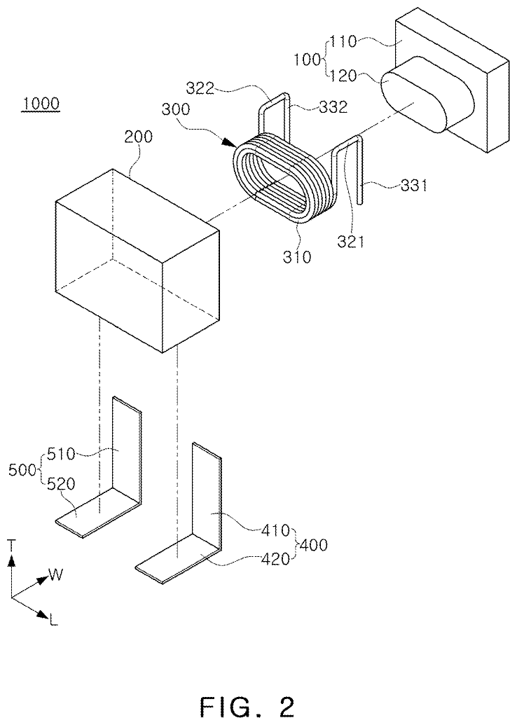

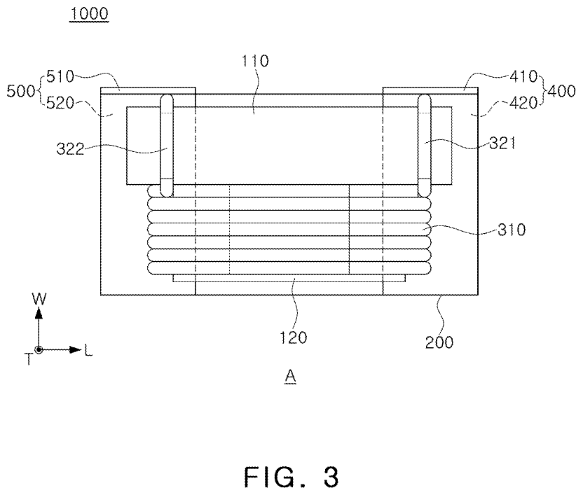

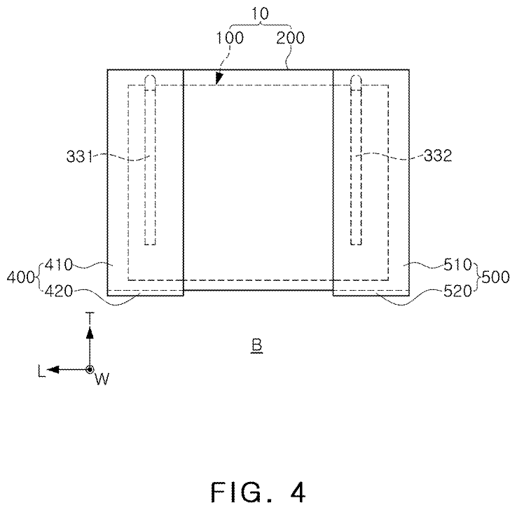

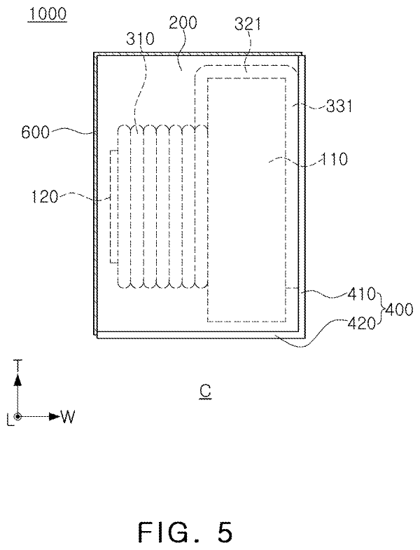

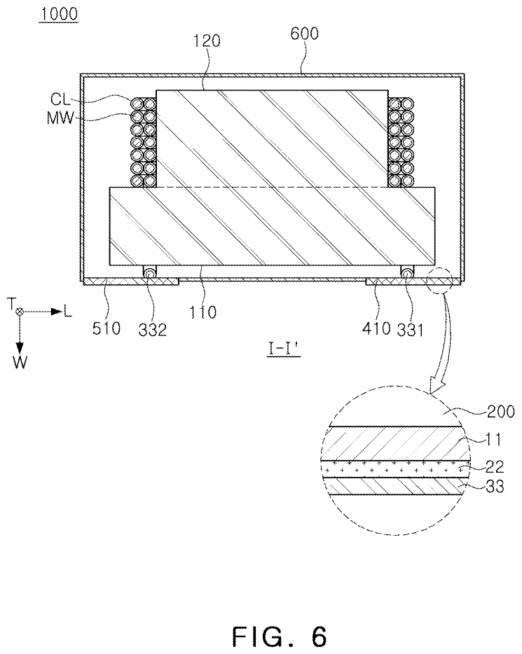

FIG. 1 is a perspective diagram illustrating a coil component 1000 according to an example embodiment. FIG. 2 is an exploded perspective diagram illustrating the coil component illustrated in FIG. 1. FIG. 3 is a diagram illustrating the coil component illustrated in FIG. 1, viewed in direction A. FIG. 4 is a diagram illustrating the coil component illustrated in FIG. 1, viewed in direction B. FIG. 5 is a diagram illustrating the coil component illustrated in FIG. 1, viewed in direction C. FIG. 6 is a cross-sectional diagram taken along I-I′ in FIG. 1.

Referring to FIGS. 1 to 6, the coil component 1000 in the first embodiment may include a body 10, a wound coil 300, and external electrodes 400 and 500. Also, the body 10 may include a mold portion 100 and a cover portion 200, and the wound coil 300 may include a wound portion 310 and lead-out portions 331 and 332, and may further include extension portions 321 and 322.

The body 10 may include a mold portion 100 and a cover portion 200. The mold portion 100 may include a base portion 110 and a core 120.

The body 10 may form an exterior of the coil component 1000 in the embodiment, and the wound coil 300 may be embedded in the body 10.

The body 10 may have a hexahedral shape.

The body 10 may include a first surface 101 and a second surface 102 opposing each other in the length direction L, a third surface 103 and a fourth surface 104 opposing each other in the width direction W, and a fifth surface 105 and a sixth surface 106 opposing each other in the thickness direction T, with respect to the directions in FIG. 1. Each of the first to fourth surfaces 101, 102, 103 and 104 of the body 10 may be a wall surface of the body 10 connecting the fifth surface 105 to the sixth surface 106 of the body 10. Hereinafter, both end surfaces of the body 10 may refer to the first surface 101 and the second surface 102 of the body 10, both side surfaces of the body 10 may refer to the third surface 103 and the fourth surface 104 of the body 10, and one surface and the other surface of the body 10 may refer to the sixth surface 106 and the fifth surface 105 of the body 10.

The body 10 may be formed such that the coil component in which the external electrodes 400 and 500 are formed may have a length of 0.8 mm, a width of 0.4 mm and a thickness of 0.8 mm in the coil component 1000, may have a length of 0.8 mm, a width of 0.4 mm and a thickness of 0.65 mm, may a length of 1.0 mm, a width of 0.7 mm and a thickness of 0.8 mm, may have a length of 1.0 mm, a width of 0.6 mm and a thickness of 0.8 mm, may have a length of 1.0 mm, a width of 0.5 mm and a thickness of 0.8 mm, may have a length of 1.0 mm, a width of 0.5 mm and a thickness of 0.65 mm, or may have a length of 1.0 mm, a width of 0.5 mm and a thickness of 0.6 mm, but an example embodiment thereof is not limited thereto. Since the above-described numerical value examples for the length, width, and thickness of the coil component 1000 do not reflect process errors, and a numerical value in a range recognized as a process error may correspond to the above-described numerical value examples.

The length of the above-described coil component 1000 may be a maximum value among dimensions of a plurality of line segments connecting two outermost boundary lines of the coil component 1000, opposing each other in the length direction L, to each other in parallel to the length direction L and spaced apart from each other in the thickness direction T, the coil component 1000 on an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an example embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other in parallel to the thickness direction T and spaced apart from each other in the length direction L, the coil component 1000 on an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the thickness direction T may be spaced apart from each other by an equal distance in the thickness direction T, but an example embodiment thereof is not limited thereto.

The width of the above-described coil component 1000 may be a maximum value among dimensions of a plurality of line segments connecting two outermost boundary lines of the coil component 1000, opposing each other in the width direction W, to each other in parallel to the width direction W and spaced apart from each other in the length direction L, the coil component 1000 on an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the thickness direction T, but an example embodiment thereof is not limited thereto.

Alternatively, each of the length, width and thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 10 may include a mold portion 100 and a cover portion 200 disposed on one surface of the mold portion 100.

Referring to FIGS. 1 to 2, the cover portion 200 may be disposed on one surface of the mold portion 100 and may cover each surface of the mold portion 100. Accordingly, the first surface, the second surface, the fourth surface, the fifth surface, and the sixth surface 101, 102, 104, 105, and 106 of the body 10 may be external surfaces of the cover portion 200, but an example embodiment thereof is not limited thereto. For example, the third surface 103 of the body 10 may be formed to include the other surface of the mold portion 100 (the rear surface of the mold portion 100 in the direction in FIG. 1), but an example embodiment thereof is not limited thereto.

The mold portion 100 may include a base portion 110 and a core 120.

The base portion 110 may have one surface and the other surface opposing each other, and a plurality of side surfaces connecting the one surface to the other surface.

The base portion 110 may support the wound coil 300.

The core 120 may protrude in the central portion of one surface of the base portion 110 by penetrating the wound coil 300. Accordingly, in the embodiments, one surface and the other surface of the base portion 110 may be considered the same as one surface and the other surface of the base portion 110, respectively.

The thickness (the size in the W direction) of the base portion 110 may be 200 μm or more. When the thickness of the base portion 110 is less than 200 μm, it may be difficult to secure rigidity. The thickness of the core 120 may be 150 μm or more, but an example embodiment thereof is not limited thereto.

The cover portion 200 may cover the mold portion 100 and the wound coil 300. The cover portion 200 may be disposed on the base portion 110, the core 120, and the wound coil 300 of the mold portion 100, may be pressurized and may be coupled to the mold portion 100. In this case, the cover portion 200 may be disposed to cover the side surface and the other surface of the base portion 110 during the pressing process, but an example embodiment thereof is not limited thereto.

At least one of the mold portion 100 and the cover portion 200 may include a magnetic material. In the embodiment, both the mold portion 100 and the cover portion 200 may include a magnetic material. The mold portion 100 may be formed by filling a mold for forming the mold portion 100 with a magnetic material. Alternatively, the mold portion 100 may be formed by filling the mold with a composite material including a magnetic material and an insulating resin. A forming process of applying high temperature and high pressure to the magnetic material or composite material in the mold may be further performed, but an example embodiment thereof is not limited thereto.

The magnetic material included in the mold portion 100 or the cover portion 200 may be ferrite or a magnetic metal powder.

Ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

Each of the mold portion 100 and the cover portion 200 may include two or more types of magnetic materials. Here, the configuration in which the magnetic materials are different may indicate that the magnetic materials may be distinct from each other by one of an average diameter, composition, crystallinity, and shape.

The insulating resin may include epoxy, polyimide, liquid crystal polymer, and the like, alone or in combination, but an example embodiment thereof is not limited thereto.

The wound coil 300 may be embedded in the body 10 and may exhibit properties of the coil component. For example, when the coil component 1000 of the present embodiment is used as a power inductor, the wound coil 300 may maintain an output voltage by storing an electric field as a magnetic field and, thereby stabilizing the power of the electronic device.

The wound coil 300 may be disposed in the body 10, and the first and second lead-out portions 331 and 332 may be exposed to the third surface of the body 10.

Referring to FIG. 1, the wound coil 300 may include a wound portion 310 disposed between the mold portion 100 and the cover portion 200 and wound around a winding axis CA perpendicular to the third surface 103 of the body 10, that is, parallel to the width direction (W direction). Here, the winding axis CA may correspond to an axis passing through the center of the core 120.

Referring to FIGS. 2 to 5, the wound coil 300 may include first and second lead-out portions 331 and 332 exposed and spaced apart from each other on the third surface 103 of the body 10, and may include first and second extension portions 321 and 322 connecting both ends of the wound portion 310 to the first and second lead-out portions 331 and 332, respectively.

The wound coil 300 may form a plurality of turns from the core 120 toward an external side of the body 10 in a length direction (L direction) of the body 10 or in the thickness direction (T direction) of the body 10.

In one embodiment, the plurality of turns may extend from an end of the second extension portion 322, then being wound around the core 120 towards an end of the core 120 in a direction in which the core 1220 protrudes from the one surface of the base portion 110, wound around the core towards back to the first surface of the base portion 110 in an opposite direction to said direction, and connected to an end of the first extension portion 321.

In one embodiment, portions of the first and second extension portions 321 and 322 may extend from both ends of the wound portion 310, respectively, along the one surface of the base portion 110 at the substantially same distance level from the one surface of the base portion 110.

Referring FIGS. 1 and 2, in the coil component 1000 in the embodiment, the wound portion 310 may be disposed perpendicularly to on a mounting surface, that is, the sixth surface 106 of the body. In other words, the winding axis CA which may be the center of each turn of the wound portion 310 may be formed in parallel with the width direction (W direction).

The winding axis CA of the wound portion 310 may be perpendicular to the third surface 103 and the fourth surface 104 of the body 10, and may be disposed in parallel to the first surface 101, the second surface 102, the fifth surface 105, and the sixth surface 106 of the body 10.

Referring to FIGS. 1 to 4, the wound portion 310 may be wound in a ring shape or an oval shape, and may have a cylindrical or oval shape in which a cylindrical or oval hollow portion is formed in the center thereof. The wound portion 310 may be an air core coil, and the core 120 may be disposed in the air core of the wound portion 310.

In the coil component 1000 in the embodiment, the wound coil 300 may be wound in two layers on an internal side and an external side, such that the number of turns of the wound portion 310 may increase, and the connection portions 321 and 322 and the lead-out portions 331 and 332 may be disposed adjacent to the base 110, but an example embodiment thereof is not limited thereto.

The first and second connection portions 321 and 322 may extend from both ends of the wound portion 310 and may be connected to the first and second lead-out portions 331 and 332, respectively.

The first and second extension portions 321 and 322 may be disposed along one surface and a side surface of the base portion 110. Specifically, the first and second extension portions 321 and 322 extending from both ends of the wound portion 310, respectively, may be spaced apart from each other, and may be disposed parallel to the thickness direction (T direction) along one surface of the base portion 110. Also, the first and second extension portions 321 and 322 may extend along the side surface of the base portion 110, that is, the side surface of the base part 110, and may be disposed parallel to the width direction (W direction), but an example embodiment thereof is not limited thereto.

The connection portions 321 and 322 may be portions other than the wound portion 310 and the lead-out portions 331 and 332 among metal wires such as a metal wire MW of which a surface is coated with an insulating coating layer CL. Accordingly, a boundary may not be formed between the connection portions 321 and 322 and the wound portion 310, and between the connection portions 321 and 322 and the lead-out portions 331 and 332, but an example embodiment thereof is not limited thereto.

Referring to FIGS. 4 and 5, the lead-out portions 331 and 332 may be connected to the first and second extension portions 321 and 322, respectively, and may be disposed on the other surface of the base portion 110, that is, the other surface of the base part 110 and may be spaced apart from each other.

That is, the first and second lead-out portions 331 and 332 may be disposed in parallel with the thickness direction (T direction), may be exposed and spaced apart from each other on the third surface 103 of the body 10, and may be connected to the first and second external electrodes 400 and 500, respectively.

Referring to FIG. 4, the first and second lead-out portions 331 and 332 may be spaced apart from each other in the length direction (L direction), and may be disposed in a linear line form parallel to the width direction (W direction), but an example embodiment thereof is not limited thereto.

The lead-out portions 331 and 332 may be portions remaining after forming the wound portion 310 and the extension portions 321 and 322 among metal wires such as Cu-wire of which a surface is coated with an insulating coating layer CL. Accordingly, a boundary may not be formed between the lead-out portions 331 and 332 and the extension portions 321 and 322, but an example embodiment thereof is not limited thereto.

Also, similarly to the wound portion 310, an insulating coating layer CL may be formed on the surfaces of the first and second lead-out portions 331 and 332, and the insulating coating layer CL may be removed from the portion of the first and second lead-out portions 331 and 332 exposed to the third surface 103 of the body 10 to conduct electricity with the external electrodes 400 and 500.

Referring to FIG. 6, the wound coil 300 may be an air-core coil, and may be configured as a metal wire MW having a circular cross-section. Differently from the example embodiment, the wound coil 300 may be configured as a flat coil, but an example embodiment thereof is not limited thereto. When the wound coil 300 is configured as a flat coil, each turn of the wound coil 300 may have a rectangular cross-section.

The wound coil 300 may be formed by winding a conductive metal, and a portion other than a portion in contact with the external electrodes 400 and 500 may be coated with an insulating coating layer CL. Specifically, the wound coil 300 may be formed by winding a metal wire MW such as a copper wire (Cu-wire) including an insulating coating layer CL coating the metal wire and the surface of the metal wire in a spiral shape. Accordingly, the entire surface of each of the plurality of turns of the wound coil 300 may be coated with the insulating coating layer CL.

The insulating coating layer CL may include epoxy, polyimide, liquid crystal polymer alone or in combination, but an example embodiment thereof is not limited thereto.

The first and second external electrodes 400 and 500 may be disposed on the body 10 and may be connected to the first and second lead-out portions 331 and 332, may function as an input/output terminal when the coil component 1000 is mounted on a printed circuit board.

Referring to FIGS. 1 and 2, the first and second external electrodes 400 and 500 may be disposed to be spaced apart from each other on the sixth surface 106 of the body 10, and may extend only onto the third surface 103 and may be connected to the first and second lead-out portions 331 and 332, respectively. In one embodiment, the first and second external electrodes 400 and 500 may be formed in an ‘L’ shape.

Specifically, the coil component 1000 in the example embodiment may have a vertical coil structure, that is, a winding direction of the wound coil 300 is parallel to the mounting surface (the sixth surface 106 of the body 10) mounted on a printed circuit board. Since the first and second lead-out portions 331 and 332 may be exposed only onto the third surface 103 of the body 10, the external electrodes 400 and 500 may extend to the third surface 103 of the body 10 and may be connected to the first and second lead-out portions 331 and 332, respectively.

That is, in the coil component 1000 in the example embodiment, the mounting surface mounted on a printed circuit board may be different from the surface to which the lead-out portions 331 and 332 are exposed, such that the external electrodes 400 and 500 may extend to the surface other than the mounting surface, and to reduce a size of the components and to secure an effective volume, the external electrodes 400 and 500 may extend onto only one surface (the third surface 103) among the side surfaces of the body 10.

Referring to FIGS. 1, 2, and 5, the external electrodes 400 and 500 may be continuously disposed on the sixth surface 106 and the third surface 103 of the body 10 and may have an L-shape with respect to the W-T cross-section.

The first external electrode 400 may be disposed on the third surface 103 of the body 10 and may include a first connection portion 410 in contact with and connected to the first lead-out portion 331, and a first pad portion 420 extending from the first connection portion 410 to the sixth surface 106 of the body 10.

The second external electrode 500 may include a second connection portion 510 disposed on the third surface 103 of the body 10 and in contact with and connected to the second lead-out portion 332, and a second pad portion 520 extending from the second connection portion 510 to the sixth surface 106 of the body 10.

The first connection portion 410 and the second connection portion 510 may be spaced apart from each other on the third surface 103 of the body 10 to not be in contact with each other, and the first pad portion 420 and the second pad portion 520 may be spaced apart from each other on the sixth surface 106 of the body 10 to not be in contact with each other.

The first and second pad portions 420 and 520 may be configured to be directly mounted through solder S when the coil component 1000 is mounted on the printed circuit board P.

The connection portions 410 and 510 and the pad portions 420 and 520 of the first and second external electrodes 400 and 500 may be formed by the same plating process, such that a boundary may not be formed therebetween. That is, the first connection portion 410 and the first pad portion 420 may be integrated with each other, and the second connection portion 510 and the second pad portion 520 may be integrated with each other. Also, the connection portions 410 and 510 and the pad portions 420 and 520 may be formed of the same metal. However, example embodiments thereof may not exclude the example in which the connection portions 410 and 510 and the pad portions 420 and 520 are formed by different plating processes and a boundary is formed therebetween.

The external electrodes 400 and 500 may be formed in a single-layer or multilayer structure.

For example, the external electrodes 400 and 500 may include a first conductive layer 11 including copper (Cu), a second conductive layer 22 disposed on the first conductive layer and including nickel (Ni), and a third conductive layer 33 disposed on the second conductive layer and including tin (Sn).

For example, the second conductive layer 22 may have a thickness of 4 μm, and the third conductive layer 33 may have a thickness of 5 μm, but an example embodiment thereof is not limited thereto.

Also, the second and third conductive layers 22 and 33 may be integrated with each other in the form of an alloy of nickel (Ni) and tin (Sn), but an example embodiment thereof is not limited thereto.

At least one of the second conductive layer 22 and the third conductive layer 33 may cover the first conductive layer 11, but an example embodiment thereof is not limited thereto.

The first conductive layer 11 may be a plating layer or a conductive resin layer formed by coating and curing a conductive resin including a conductive powder including at least one of copper (Cu) and silver (Ag) and a resin. The second conductive layer 22 and the third conductive layer 33 may be plating layers, but an example embodiment thereof is not limited thereto.

The external electrodes 400 and 500 may be formed by vapor deposition and/or electroplating such as sputtering, but are not limited thereto.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), or alloys thereof, but an example embodiment thereof is not limited thereto.

Referring FIGS. 5 and 6, the coil component 1000 according to the present embodiment may further include an insulating layer 600 covering the fourth surface 104 of the body 10.

Also, the insulating layer 600 includes a region of the third surface 103 of the body 10 excluding the region where the connection portions 410 and 510 of the external electrodes 400 and 500 are disposed, and the sixth surface of the body 10. The surface 106 may be disposed in an area other than the area in which the pad portions 420 and 520 of the external electrodes 400 and 500 are disposed.

In this case, the insulating layer 600 may be used as a plating resist in forming the external electrodes 400 and 500 by electroplating, but an example embodiment thereof is not limited thereto.

Also, the insulating layer 600 may be further disposed on at least a portion of the first, second, and fifth surfaces 101, 102, 105 of the body 10.

### Second and Third Embodiments

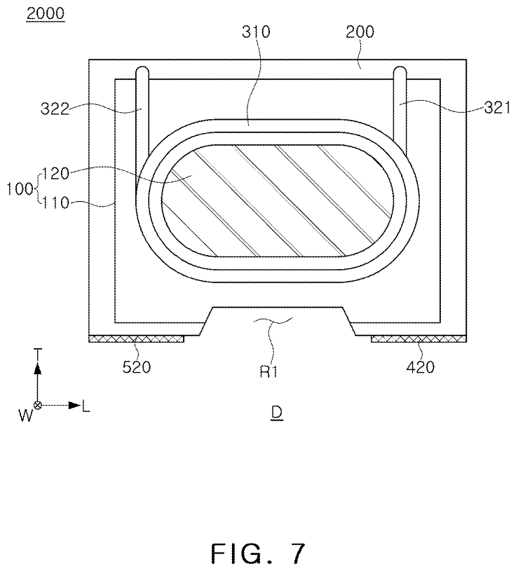

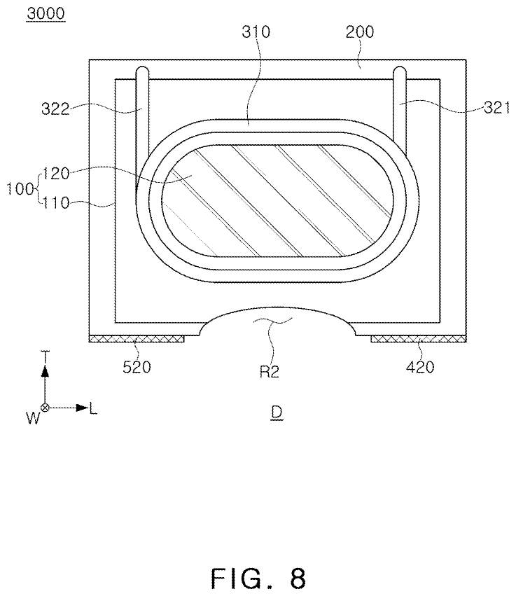

FIG. 7 is a diagram illustrating the coil component in FIG. 1 according to a second example embodiment, viewed in direction D. FIG. 8 is a diagram illustrating the coil component in FIG. 1 according to a third example embodiment, viewed in direction D.

Referring to FIGS. 7 and 8, the coil components 2000 and 3000 according to the second and third embodiments may be different from the coil component 1000 according to the first embodiment in that the recesses R1 and R2 may be formed in the space between the first and second external electrodes 400 and 500 of the sixth surface 106. Accordingly, in the embodiment, only the recesses R1 and R2 different from the first embodiment and the shapes of the mold portion 100 and the cover portion 200 according to the recesses will be described. For the other configuration of the present embodiment, the description in the first embodiment may be applied.

The recesses R1 and R2 may prevent unnecessary removal of the plating resist required for forming the first and second external electrodes 400 and 500 by electroplating. That is, for plating the external electrodes 400 and 500, a plating resist including openings corresponding to the regions in which the external electrodes 400 and 500 are formed may be formed on the sixth surface 106 of the body 10, and the opening is formed by polishing in this process, regions other than the regions in which the external electrodes 400 and 500 are formed may be removed, and the recesses R1 and R2 may prevent the removal. Accordingly, an insulating layer such as a plating resist may be disposed in the recesses R1 and R2.

Also, when the recesses R1 and R2 are formed in the sixth surface 106 of the body 10, and when the coil components 2000 and 3000 in the embodiment are mounted on a printed circuit board, the risk of a short circuit between the first and second external electrodes 400 and 500 through S may be reduced.

Referring to FIGS. 7 and 8, the first and second recesses R1 and R2 may be formed between the first and second external electrodes 400 and 500, that is, in a space between the pad portions 420 and 520, on the sixth surface 106 corresponding to the mounting surface of the body 10.

The cross-sectional areas of the recesses R1 and R2 may decrease from the sixth face 106 of the body 10 toward an internal side of the body with respect to the L-W cross-section parallel to the sixth face 106 of the body 10. That is, the cross-sectional areas of the recesses R1 and R2 may be formed to be smallest on the innermost surface with respect to the L-W cross-section.

In this way, as the region of the recesses R1 and R2 adjacent to the external electrodes 400 and 500 may increase the cross-sectional area, that is, increasing the spacing, and may decrease the cross-section toward the internal side of the body 10, an effective volume may be further secured as compared to the example in which the cross-sectional areas of the recesses R1 and R2 are constant.

Referring to FIG. 7, the recess R1 may have a trapezoidal shape with respect to an L-T cross-section parallel to the third surface 103 of the body 10.

Referring to FIG. 8, the recess R2 may have an arc-shaped shape with respect to an L-T cross-section parallel to the third surface 103 of the body 10.

Meanwhile, the shape of the recesses R1 and R2 may be varied if desired, and an example embodiment thereof is not limited to the above shape.

Since the recesses R1 and R2 are formed after the body 10 is formed and before the external electrodes 400 and 500 are disposed, a portion of the side surface of the base portion 110 and the side surface of the cover portion 200 toward the sixth surface 106 of the body 10 may be recessed, but an example embodiment thereof is not limited thereto.

### Fourth Embodiment

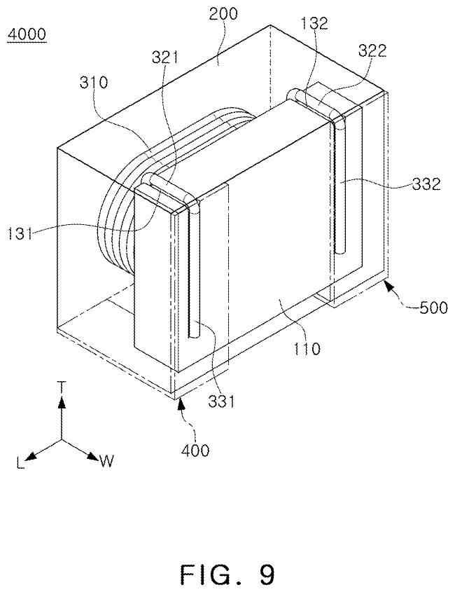

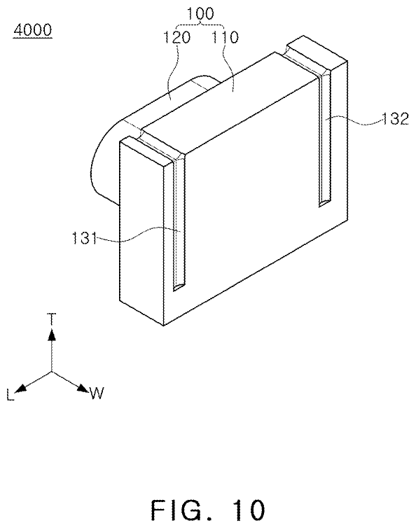

FIG. 9 is a perspective diagram illustrating a coil component according to a fourth example embodiment. FIG. 10 is a diagram illustrating a mold portion of a coil component according to a fourth example embodiment.

Referring to FIGS. 9 and 10, the coil component 4000 according to the embodiment may be different from the coil component 1000 according to the first embodiment in which the mold portion 100 may include a groove portion 131. Accordingly, in the embodiment, only the mold portion 100 and the groove portions 131 and 132 formed in the mold portion 100 different from the first embodiment will be described. For the other configuration of the present embodiment, the description in the first embodiment may be applied.

Referring to FIGS. 9 and 10, in the coil component 4000 in the embodiment, first and second groove portions 131 and 132 accommodating the first and second extensions 321 and 322, respectively, may be formed one region of the in which the first and second extension portions 321 and 322 are disposed.

When the groove portions 131 and 132 are formed in the mold portion 100 as in the coil component 4000 in the embodiment, the direction in which the extension portions 321 and 322 and the lead-out portions 331 and 332 of the wound coil 300 are disposed may be guided.

Also, since a portion of each of the extension portions 321 and 322 and the lead-out portions 331 and 332 is accommodated in the groove portions 131 and 132, the size of the coil component 4000 in width direction (W direction) may further decrease.

That is, when the lead-out portions 331 and 332 are accommodated in the groove portions 131 and 132 by a predetermined depth, while connection between the lead-out portions 331 and 332 and the connection portions 410 and 510 of the external electrodes 400 and 500 are maintained, the surface of the base portion 110 on which the groove portions 131 and 132 are formed and the third surface 103 of the body 10 may coincide with each other. Accordingly, the coil component 4000 having a width smaller than that of the coil component 1000 according to the first embodiment may be implemented, but an example embodiment thereof is not limited thereto.

Referring to FIG. 9, the surface on which the wound coil 300 is disposed may be defined as one surface of the base portion 110, the surface opposing this surface may be defined as the other surface of the base portion 110, and the surface connecting the one surface to the other surface of the base portion 110 may be defined as a side surface. The first and second groove portions 131 and 132 may be spaced apart from each other on one side surface of the base portion 110 and may accommodate the first and second extensions 321 and 322, respectively.

Also, the first and second groove portions 131 and 132 may extend from one side surface of the base portion 110 to the other surface of the base portion 110 and may accommodate the first and second draw-out parts 331 and 332, respectively.

Referring to FIG. 10, the first and second groove portions 131 and 132 may be to be formed parallel to the width direction W on one side surface of the base portion 110, that is, one side surface of the base portion 110, and may be formed parallel to the thickness direction T on the other surface of the base portion 110, that is, the other surface of the base part 110, but an example embodiment thereof is not limited thereto.

The groove portions 131 and 132 may be formed in a shape corresponding to the extension portions 321 and 322 and the lead-out portions 331 and 332. For electrical connection between the coil portion 300 and the external electrodes 400 and 500, a portion of the lead-out portions 331 and 332 may need to protrude from the groove portions 131 and 132, and accordingly, the depth of the groove portions 131 and 132 may be configured to be smaller than a diameter on the L-W cross-section of the lead-out portions 331 and 332.

When the groove portions 131 and 132 are formed deeply enough to accommodate most of the lead-out portions 331 and 332, the surface on which the lead-out portions 331 and 332 and the external electrodes 400 and 500 are in contact with each other may coplanar with the other surface of the base portion 110. In this case, the third surface 103 of the body 10 may include the other surface of the base portion 110, but an example embodiment thereof is not limited thereto.

(Effect During Mounting and Effect of Increased Effective Volume)

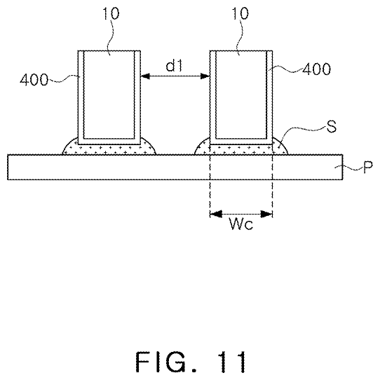

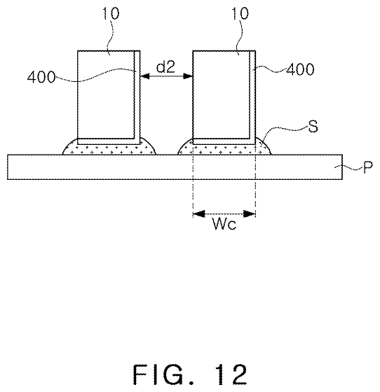

FIGS. 11 and 12 are diagrams illustrating a difference in a mounting distance depending on the shape of the external electrode 400.

FIG. 11 is a diagram illustrating a distance between coil components having a U-shaped external electrode when being mounted on a printed circuit board. FIG. 12 is a diagram illustrating a distance between coil components 1000, 2000, 3000, and 4000 having an L-shaped external electrode when being mounted on a printed circuit board as in the example embodiment.

Referring to FIGS. 11 and 12, assuming that two coil components are mounted adjacent to each other on a printed circuit board P, when the widths We of the coil components are the same, the risk of short circuit and the effective volume may be varied depending on the shape of the external electrode 400.

FIG. 11 illustrates the example in which the external electrode 400 is disposed throughout the three surfaces 103, 104, and 106 of the body 10 in a U-shape, and when the distance d1 between coil components adjacent to each other is decreased, the distance between the external electrodes 400 disposed on each coil component may decrease, such that the risk of a short circuit may increase.

Also, in this case, the effective volume of the body 10 may be reduced by the volume occupied by the external electrodes 400 on both sides based on the same size of the coil component.

FIG. 12 illustrates the example in which the external electrode 400 is disposed throughout the two surfaces 103 and 106 of the body 10 in an L-shape similarly to the coil components (1000, 2000, 3000, and 4000 in the embodiments, and the external electrode 400 may be formed on only one side between coil components adjacent to each other, and the area occupied by the solder S may also be reduced, and the body surface 10 may oppose the external electrode 400, not between the external electrodes 400, such that the risk of a short circuit may also be reduced, and the distance d2 between the coil components adjacent to each other may be further reduced when the components are mounted.

Also in this case, as compared to the U-shape in which the external electrodes 400 are disposed on the lower surface 106 and both side surfaces 103 and 104 of the body 10, the effective volume of the body 10 may be increased by the volume occupied by the external electrode 400 disposed on the other side 104 of the body 10, based on the same size of the coil component.

Referring to FIGS. 11 and 12, the distance between components adjacent to each other in the same mounting area may be d1>d2, and accordingly, as in the coil components 1000, 2000, 3000, and 4000 according to the embodiment, when the external electrodes 400 and 500 are disposed in an L-shape, that is, only on the lower surface 106 and one side surface 103 of the body 10, the risk of a short circuit between coil components adjacent to each other may be reduced, and effective volume may increase based on the same size of the coil components, such that inductance properties may improve.

TABLE 1

| | | | | Effective volume | Increase of ratio of |
|---|---|---|---|---|---|
| | | | | increase when | effective volume |
| | | | | external electrode | when external |
| | | | Total | on the other side | electrode on the |
| L | W | T | volume | is removed | other side is removed |
| (mm) | (mm) | (mm) | (mm³) | (mm³) | (%) |
| 0.8 | 0.4 | 0.8 | 0.256 | 0.0058 | 2.27 |
| 0.8 | 0.4 | 0.65 | 0.208 | 0.0047 | 2.26 |
| 1 | 0.7 | 0.8 | 0.56 | 0.0072 | 1.29 |
| 1 | 0.6 | 0.8 | 0.48 | 0.0072 | 1.50 |
| 1 | 0.5 | 0.8 | 0.4 | 0.0072 | 1.80 |
| 1 | 0.5 | 0.65 | 0.325 | 0.0059 | 1.82 |
| 1 | 0.5 | 0.6 | 0.3 | 0.0054 | 1.80 |

Referring to Table 1, as compared to the example in which the external electrodes 400 and 500 are formed throughout the three surfaces 103, 104, and 106 of the body 10 in a U-shape as in FIG. 11, the increase in effective volume and the increase ratio thereof when the external electrodes 400 and 500 of the other side surface 104 of the body 10 are removed are listed.

As in the embodiments, it is indicated that, in the case of the structure in which the external electrodes 400 and 500 of the other side 104 of the body 10 are removed, that is, the L-shaped structure in which the external electrodes 400 and 500 are only disposed on the lower surface 106 of the body 10 and on one side surface 103, 1.29% to 2.27% of an effective volume may be secured depending on the size of the coil component as compared to the U-shaped external electrodes 400 and 500.

According to the aforementioned example embodiments, a coil component which may have a reduced size and a low-profile and may have high capacitance properties by securing an effective volume may be provided.

Also, a coil component in which short circuits between components adjacent to each other may be prevented when being mounted on a printed circuit board and may thus be easily integrated may be provided.

While the example embodiments have been illustrated and described above, it will be apparent to those skilled in the art that modifications and variations could be made without departing from the scope of the present disclosure as defined by the appended claims.

What is claimed is:

1. A coil component, comprising:
a body having a first surface and a second surface opposing each other, and a first side surface and a second side surface connecting the first surface to the second surface and opposing each other;
a wound coil disposed in the body, and including a wound portion wound around a winding axis perpendicular to the first side surface of the body and first and second lead-out portions spaced apart from each other on the first side surface of the body; and
first and second external electrodes spaced apart from each other on the first surface of the body, extending only onto the first side surface of the body and connected to the first and second lead-out portions, respectively.

2. The coil component of claim 1,
wherein the body includes a mold portion having a base portion and a core protruding from a center of a first surface of the base portion, and a cover portion disposed on the first surface of the base portion, and
wherein the wound portion is disposed between the mold portion and the cover portion and is wound around the core.

3. The coil component of claim 2,
wherein the wound coil further includes first and second extension portions connecting both ends of the wound portion to the first and second lead-out portions, respectively, and
wherein the first and second extension portions are disposed along the first surface and a side surface of the base portion.

4. The coil component of claim 2, wherein the first and second lead-out portions are spaced apart from each other on a second surface of the base portion opposing the first surface of the base portion and are in contact with the first side surface of the body.

5. The coil component of claim 1,
wherein the first external electrode includes a first connection portion disposed on the first side surface of the body and connected to the first lead-out portion, and a first pad portion extending from the first connection portion and disposed on the first surface of the body, and
wherein the second external electrode includes a second connection portion disposed on the first side surface of the body and connected to the second lead-out portion, and a second pad portion extending from the second connection portion and disposed on the first surface of the body.

6. The coil component of claim 1, wherein a recess is formed in a space between the first and second external electrodes on the first surface of the body.

7. The coil component of claim 6, wherein a cross-sectional area of the recess decreases from the first surface of the body toward an inner side of the body on a cross-section parallel to the first surface of the body.

8. The coil component of claim 7, wherein the recess has a trapezoidal shape on a cross-section parallel to the first side surface of the body.

9. The coil component of claim 7, wherein the recess has an arcuate shape on a cross-section parallel to the first side surface of the body.

10. The coil component of claim 3, wherein the mold portion includes first and second groove portions spaced apart from each other on the side surface of the base portion and accommodating the first and second extension portions, respectively.

11. The coil component of claim 10, wherein the first and second groove portions extend from the side surface of the base portion onto a second surface of the base portion opposing the first surface of the base portion and accommodate the first and second lead-out portions, respectively.

12. The coil component of claim 1, wherein the first and second external electrodes include a first metal layer disposed on the body and a second metal layer disposed on the first metal layer.

13. The coil component of claim 12, wherein the first and second external electrodes further include a third metal layer disposed on the second metal layer.

14. The coil component of claim 1, further comprising:
an insulating layer covering the second side surface of the body.

15. The coil component of claim 14,
wherein the body further has a first end surface and a second end surface opposing each other and connecting the first surface to the second surface of the body, connecting the first side surface to the second surface of the body, and
wherein the insulating layer extends to the first end surface and the second end surface of the body, and covers a region in which the external electrode is not disposed among the first surface and the first side surface of the body.

16. The coil component of claim 1, wherein the wound coil includes a conductive metal, and a surface of a portion other than a portion in contact with the first and second external electrodes is coated with an insulating coating layer.

17. A coil component, comprising:
a body having a first surface and a second surface opposing each other, and a first side surface and a second side surface connecting the first surface to the second surface and opposing each other;
a wound coil disposed in the body, and including a wound portion wound around a winding axis perpendicular to the first side surface of the body and first and second lead-out portions spaced apart from each other; and
first and second external electrodes spaced apart from each other, each having an ‘L’ shape disposed on the first surface and the first side surface of the body, the first and second external electrodes being connected to the first and second lead-out portions, respectively.

18. The coil component of claim 17, wherein the first and second lead-out portions extend from the wound portion, and are spaced apart from each other and in contact with the first side surface of the body.

19. The coil component of claim 17,
wherein the body includes a mold portion having a core protruding from a center of a first surface of the base portion, and a cover portion disposed on the first surface of the base portion, and
wherein the wound portion is disposed between the mold portion and the cover portion and is wound around the core.

20. The coil component of claim 19,
wherein the wound coil further includes first and second extension portions connecting both ends of the wound portion to the first and second lead-out portions, respectively, and
wherein the first and second extension portions are disposed along the first surface and a side surface of the base portion.

21. The coil component of claim 20,
wherein the wound portion include a plurality of turns extending from an end of the second extension portion, wound around the core towards an end of the core in a direction in which the core protrudes from the first surface of the base portion, wound around the core towards back to the first surface of the base portion in an opposite direction to said direction, and connected to an end of the first extension portion.

22. The coil component of claim 20, wherein portions of the first and second extension portions extend from both ends of the wound portion, respectively, along the first surface of the base portion at the substantially same distance level from the first surface of the base portion.

23. A coil component, comprising;
a body having a first surface and a second surface opposing each other, and a first side surface and a second side surface connecting the first surface to the second surface and opposing each other;
a wound coil disposed in the body, and including a wound portion wound around a winding axis perpendicular to the first side surface of the body and first and second lead-out portions spaced apart from each other on the first side surface of the body; and
first and second external electrodes spaced apart from each other, disposed on the first surface and the first side surface of the body, and connected to the first and second lead-out portions, respectively.

24. The coil component of claim 23, wherein the first and second lead-out portions extend from the wound portion, and are spaced apart from each other and in contact with the first side surface of the body.

25. The coil component of claim 23,
wherein the body includes a mold portion having a core protruding from a center of a first surface of the base portion, and a cover portion disposed on the first surface of the base portion, and
wherein the wound portion is disposed between the mold portion and the cover portion and is wound around the core.

26. The coil component of claim 25,
wherein the wound coil further includes first and second extension portions connecting both ends of the wound portion to the first and second lead-out portions, respectively, and
wherein the first and second extension portions are disposed along the first surface and a side surface of the base portion.
